(19) United States
(12) Patent Application Publication
(10) Pub. No.: US 2005/0115935 A1
(43) Pub. Date: Jun. 2, 2005

(54) Cutting or perforating water-soluble film

(76) Inventors: David Brian Edwards, Hertfordshire (GB); Brian George Bryden, Warwickshire (GB)

Correspondence Address: GREER, BURNS & CRAIN, 300 S WACKER DR, 25TH FLOOR, CHICAGO, IL, 60606, US

(21) Appl. No.: 10/502,530

(22) PCT Filed: Jan. 24, 2003
(86) PCT No.: PCT/GB03/00276

(30) Foreign Application Priority Data
Jan. 26, 2002 (GB) 02018562

(51) Int. Cl. B23K 26/14

(52) U.S. Cl. 219/121.67

(57) ABSTRACT

A process for cutting or perforating a water-soluble or water-dispersible film or stack of films in the form of a web comprising a plurality of compartments by which each compartment is cut or perforated by applying a laser beam to the film or stack of films. The process for producing a water-soluble or water-dispersible container containing a composition comprises: a producing a base web water-soluble or water-dispersible film containing a plurality of pockets; b. filling each pocket with a composition; c. sealing the pockets with a top web water-soluble or water-dispersible film to produce closed containers; and d. separating at least one container from the plurality of containers by cutting or perforating the combined web with a laser beam.

The present invention relates to a process for cutting or perforating a polyvinyl alcohol (PVOH) film, in particular laminates and stacks thereof.

PVOH film is finding an increasingly large number of uses. Many PVOH films are water-soluble, and can be used to prepare containers containing compositions such as laundry detergents, hazardous compositions, and ingestible compositions. Examples of such containers are described in, for example, WO 00/55068.

PVOH film is difficult to process. It is water soluble and, to a certain extent, hygroscopic. It is sensitive to changes in temperature and changes in humidity. In addition it has a high tensile strength, for example many times greater than that of polyethylene, but lacks rigidity as compared to other films such as those made from PVC, polypropylene and polystyrene.

These factors make it difficult to cut PVOH films satisfactorily. PVOH has, up to now, only been moderately successfully cut on an industrial scale using flying knives, crush cut roller knives or precision punch cutting systems. Even these cutting methods have proved to be problematic. The tensile and elongation properties of the PVOH film mean that considerable heat is generated during the cutting. This, coupled with the variable nature of its physical properties due to its sensitivity to temperature and humidity changes, means that it is difficult to cut PVOH film reliably and repeatedly. This can easily be demonstrated by trying to tear a perforated PVOH film along its line of perforations. The stretch characteristics of the film mean that the film is almost always distorted, no matter how much care is taken when tearing the film along the perforations. Furthermore, jamming of mechanical cutting means can easily occur. Regular maintenance is therefore required to keep cutting edges clean and clear from heated PVOH debris. If this debris is not removed, it can cause jams or damage the cutting edges, both of which can lead to major production delays. It has also been found that the knives quickly loose their cutting edge and have to be sharpened or replaced, again leading to increased down-time of the cutting apparatus.

Furthermore, precision punches are heavy and expensive items of equipment which require substantial support and hence careful consideration as to their placement in a production line. This generally means that a production line such as a thermoforming apparatus has to be extended in order to accommodate such a punch.

This has been found to be a particular disadvantage when cutting PVOH containers from a line of, or a two-dimensional array of, containers, for example as produced by a continuous motion or an intermittent motion thermoforming apparatus. The gap between each container must be fairly large in order to ensure that the containers themselves are not damaged when cutting or perforating (by mechanical means) the film between them due to localised stretching of the web. Typically, such thermoformed PVOH containers are designed to have a seal width of 3.0-7.0 mms and the distance between the outer periphery of the sealed parts of a stack of films around neighbouring containers (“the gap” between containers) is 5.0-15.0 mms.

We have found a method of cutting or perforating PVOH film or a stack of PVOH films which overcomes the above disadvantages.

The present invention provides a process for cutting or perforating a water-soluble or water-dispersible film or stack of films in the form of a web comprising a plurality of containers by which at least one container is cut or perforated by applying a laser beam to the film or stack of films.

Thus one or more layers of PVOH film are cut or perforated utilising a focused laser beam of a wavelength which is absorbed by PVOH. Typically such lasers operate in the infra-red range of the spectrum between 0.7 and 20 μm.

The process allows the web to be cut or perforated extremely close to the seal of the container. Thus the distance between the outer periphery of the sealed stack of films around neighbouring containers is substantially less than that required for mechanical cutting or perforation.

Laser cutting has been the subject of many publications including, for example:
The Laser Institute of America Guide to Laser Cutting, published by the Laser Institute of America: ISBN 0-912035-17-X and
CO2 Laser Cutting, published by Springer Verlag: ISBN 1-85233-047-3

The present invention additionally provides a process for producing a water-soluble or water-dispersible container containing a composition which comprises:
a. producing a base web water-soluble or water-dispersible film containing a plurality of pockets;
b. filling each pocket with a composition;
c. sealing the pockets with a top web water-soluble or water-dispersible film to produce closed containers; and
d. separating at least one container from the plurality by cutting the top and bottom web films with a laser beam.

The present invention also provides for the use of a laser beam to cut or perforate one or more layers of PVOH film.

By “cutting”, we mean a process in which a laser beam is drawn over a surface of one or more layers of PVOH film, by moving the laser beam, by moving the film either in continuous motion or in intermittent motion or by a combination of moving the laser beam and moving the film. The cut may be of any length and may separate at least one piece of PVOH film from the remainder, although this is not essential.

By “perforating”, we mean a process in which a series of holes, short cuts or serrations are formed in one or more layers of PVOH film, particularly at least 3, 5 or 10 holes or cuts, in a pattern. The pattern may be any shape, for example a straight line or a curved line, whether producing a complete periphery or not. The perforations assist the subsequent tearing of the film, for example by hand.

The method of the present invention eliminates the adverse effect of localised heating of the film around the cutting area. Although by use of this invention, elevated temperatures may still be generated around the cut portion of the film, this no longer matters since the heated film has no knife or other mechanical device to which to stick. Furthermore, the success of the method is entirely independent of the tensile and elongation properties of the film.

Additionally, since the laser beam can be precisely controlled, for example by appropriate software, it can be used to cut or perforate between containers even when the distance between the outer periphery of the sealed stack of films around neighbouring containers (“the gap”) is substantially less than that required for mechanical cutting or perforating. This is because the laser cutting or perforating operation will no longer need to take into account the variable effects of web stretch or wander. In the limiting case, although this is not preferred, we have shown that the gap between containers may be eliminated altogether.

Laser heads can be supported easily almost anywhere on a production line, with the beam delivered through an appropriate beam delivery system such as a galvanometer based laser scanning head. This has considerable practical advantage in that the production line can be shortened, thus possibly enabling a line to be installed where it could not if a precision punch or other mechanical means were used for cutting or perforating.

The process of the present invention can use a variety of laser systems but typically a medium powered CO2 laser and galvanometer based beam delivery system would be used in this application. Successful results have been obtained with a 25 watt CO₂ laser operating at a wavelength of 10.6 μm and a laser head of 200 mm focal length. The laser head may be integral with the remainder of the laser, or may be separate and linked to the remainder of the laser by a fibre optic cable.

On thin PVOH film applications, very high speeds can be anticipated with medium range laser powers when cutting on a continuous basis. Perforating can be controlled by the pulse repetition frequency of the laser.

The PVOH film may be produced by, for example, casting or blowing. The film may be a single film. However, it is possible for the film to be in the form of a laminate, for example with another PVOH film or with another water-soluble polymer such as a cellulose derivative such as hydroxypropyl methyl cellulose (HPMC), poly(vinylpyrrolidone) (PVP), poly(acrylic acid) or an ester thereof, poly(maleic acid) or an ester thereof, or gelatin. Copolymers of any of the above may also be used. The laminate may, for example, have 2, 3, 4, 0.5 or 6 or more layers.

The PVOH is preferably water-soluble (which term is taken to include water-dispersible), for example in cold or in warm Water. By choosing an appropriate PVOH polymer, it is possible to ensure that it dissolves in a prescribed time at a desired temperature. Thus, for example, the PVOH film may be selected to be soluble in cold water (20° C. or less), but may be selected to be insoluble in cold water and only become soluble in warm or hot water having a temperature of, for example, 30° C., 40° C., 50° C. or even 60° C. The PVOH may be partially or fully alcoholised or hydrolysed. For example it may be from 40 to 100%, preferably from 70 to 92%, more preferably about 88%, alcoholised or hydrolysed. The degree of hydrolysis is known to influence the temperature at which the PVOH will dissolve in water. Modified PVOH polymers such as ethoxylated PVOH may also be used.

The PVOH film may consist essentially of, or consist of, PVOH. It is possible for suitable additives such as plasticisers, lubricants and colouring agents to be added. Components which modify the properties of the polymer may also be added. Plasticisers are generally used in an amount of up to 20 wt %, for example from 10 to 20 wt %. Lubricants are generally used in an amount of 0.5 to 5 wt %. The PVOH is therefore generally present in an amount of from 75 to 84.5 wt %. Suitable plasticisers are, for example, pentaerythritols such as depentaerythritol, sorbitol, mannitol, glycerine and glycols such as glycerol, ethylene glycol and polyethylene glycol; Solids such as talc, stearic acid, magnesium stearate, silicon dioxide, zinc stearate or colloidal silica may be used as lubricants.

It is also possible to include one or more particulate solids in the film in order to accelerate the rate of dissolution thereof. Dissolution of the solid in water is sufficient to cause an acceleration in the break-up of the film, particularly if a gas is generated.

Examples of such solids are alkali and alkaline earth metal, such as sodium, potassium, magnesium and calcium, bicarbonate and carbonate, in conjunction with an acid. Suitable acids are, for example, acidic substances having carboxylic or sulfonic acid groups or salts thereof. Examples are cinnamic, tartaric, mandelic, fumaric, maleic, malic, palmoic, citric and naphthalene disulfonic acids, as free acids or as their salts, for example with alkali or alkaline earth metals.

The film may have any desired thickness. A preferred thickness is 20 to 150 μm, more preferably 30 to 100 μm, especially 40 to 90 μm, more especially 50 to 80 μm and most especially 60 to 80 μm. A laminated film may also be used. A suitable thickness of the laminate is 30 to 300 μm, more preferably 40 to 200 μm, especially 40 to 0.100 μm.

The PVOH film may be unoriented, mono-axially oriented or bi-axially oriented. In a laminate, each film layer may independently be unoriented, mono-axially oriented or bi-axially oriented. If more than one film in the laminate is oriented, they may have the same orientation, or their planes of orientation may be different if desired. The final laminate may also be unoriented, mono-axially oriented or bi-axially oriented. Orientation may be provided by, for example, stretching each film before it is laminated or by stretching the laminate after it is formed.

Lamination may be carried out by any desired process. For example, lamination can be carried out before the laminate is further processed. Thus the films making up the film stack may be heated to adhere them together. An adhesive layer may also be provided.

Lamination may be assisted by the use of pressure or vacuum. If two adjacent films are soluble in the same solvent, that solvent may be applied to one or both adjacent surfaces to ensure adhesion. If the films are water-soluble, a suitable solvent is water or an aqueous solution of the polymers making up the films. For example, if the PVOH is water-soluble, a suitable solvent is an aqueous solution of PVOH. The adhesive may be applied, for example, by casting or by printing. Desirably a pattern of adhesive is applied, such as a stipple pattern.

It is also possible for lamination to be carried out simultaneously with another process. For example, lamination can occur in a thermoforming mould. This process allows for the production of a thermoformed, laminated film in one step, avoiding the use of an additional step using heating or adhesive, along with pressure or vacuum, to laminate the films. This reduces capital expenditure and other costs, as well as reducing complexity and production time, as compared with processes in which the laminate is pre-formed.

In a preferred embodiment of the invention, the PVOH containers are in the form of a web comprising a plurality of compartments and are cut or perforated between at least two of the compartments. The compartments may, for example, be provided by vacuum forming or thermoforming a base web PVOH film and sealed by placing a top web film on top of the filled pocket and sealing the top web film to the base web film making up the pocket, for example by heat sealing. Such a process is disclosed, for example, in WO 00/55068. Other processes for making water-soluble containers include, for example, vertical form-fill-sealing, horizontal form-fill-sealing and processes providing pillow packs.

The container is desirably water-soluble so that it can simply be added to an aqueous environment where it will dissolve to release its contents.

A suitable thermoforming temperature for PVOH or ethoxylated PVOH is, for example, from 90 to 130° C. especially 90 to 120° C. A suitable forming pressure is, for example, 60 to 138 kPa (10 to 20 p.s.i.), especially 69 to 103 kPa (10 to 15 p.s.i.). A suitable forming vacuum is 0 to 4 kPa (0 to 20 mbar), especially 0 to 2 kPa (0 to 20 mbar). A suitable dwell time is, for example, 0.4 to 2.5 seconds, especially 1.5 to 2.0 seconds.

One skilled in the art can choose an appropriate temperature, pressure or vacuum and dwell time, for example to achieve a laminate of the desired integrity during simultaneous thermoforming and lamination. The amount of vacuum or pressure used depends on the thickness and composition of the film. While desirably conditions are chosen within the above ranges, it is possible to use one or more of these parameters outside the above ranges, although it may be necessary to compensate by changing the values of the other parameters.

The top web film in a thermoforming or vacuum forming process is preferably water-soluble. The base web film forming the pocket and the top web film may be manufactured from the same or different compositions. The top web or the bottom web film may be a single film or a laminate. At least one, and preferably both, of the films making up the container is based upon PVOH or other water-soluble polymers.

The top web film desirably has a thickness which is less than that of the base web film making up the pocket because it will not generally be thermoformed so localised thinning of the sheet will not occur. It is also desirable to have a thickness which is less than that of the film stack to ensure a sufficient heat transfer through the films to soften the base web, for example during heat sealing. The thickness of the covering film will generally be from 20 to 160 μm, preferably from 40 to 100 μm.

The films may be sealed together by any suitable means, for example by means of an adhesive or by heat sealing or by a combination thereof.

The composition may be any composition which is intended to be released in an aqueous environment if the container is water-soluble. Thus, for example, it may be a pesticidal composition such as a biocidal composition or a plant protection agent (for instance an insecticide, fungicide, herbicide, acaricide, or nematocide), a plant growth regulator, or a plant nutrient. It may be a hazardous composition which is potentially toxic or damaging or detrimental to health or the environment. It may be a non-hazardous or ingestible composition, for example, a pharmaceutical or nutraceutical composition. Such compositions are generally packaged in quantities of from 0.01 g to 7 kg, preferably 0.1 g to 2 kg, when in solid form. When in liquid or gelled form, such compositions are generally packaged in amounts of from 1 ml to 10 litres, preferably 0.1 to 2.0 litres, especially from 0.1 to 1.0 litres.

The composition may also be a fabric care, surface care or dishwashing composition. Thus, for example, it may be a dishwashing, water-softening, laundry or detergent composition, or a rinse aid. Such compositions may be suitable for use in a domestic washing machine. The composition may also be a disinfectant, antibacterial or antiseptic composition, or a refill composition for a trigger-type spray. Such compositions are generally packaged in amounts of from 5 to 100 g, especially from 15 to 40 g. For example, a dishwashing composition may weigh from 15 to 30 g, a water-softening composition may weigh from 15 to 40 g, and a laundry composition may weigh from 15 to 40 g.

The composition(s) may be a solid. For example, it may be a particulate or granulated solid, or a tablet. It may also be a liquid, which may be thickened or gelled if desired. The liquid composition may be non-aqueous (i.e. anhydrous) or aqueous, for example comprising less than or more than 5 wt % total or free water (not a very clear example). An anhydrous composition generally contains less than 1 wt %, preferably less than 0.5 wt % water. The composition may have more than one phase. For example it may comprise an aqueous composition and a liquid composition which is immiscible with the aqueous composition. It may also comprise a liquid composition and a separate solid composition, for example in the form of a ball, or pill or speckles. The liquid composition may be thickened or gelled.

If the composition is an aqueous liquid having a relatively high water content, for example above 5 wt % water, it may be necessary to take steps to ensure that the liquid does not attack the water-soluble polymer if it is soluble in cold water, or water up to a temperature of, say, 35° C. Steps may be taken to treat the inside surfaces of the container, for example by coating it with suitable protective agents, or to adapt the composition to ensure it does not dissolve the polymer. For example, it has been found that ensuring the composition has a high ionic strength or contains an agent which minimises water loss through the walls of the container will prevent the composition from dissolving the film wall of the container from the inside. This is described in more detail in Ep-A-518,689 and WO 97/27,743.

The containers produced by the process of the present invention may, if desired, have a maximum dimension of 50 cm, excluding any flanges. For example, a container may have a length of 1 to 5 cm, especially 3.5 to 4.5 cm, a width of 1.5 to 3.5 cm, especially 2 to 3 cm, and a height of 1 to 2 cm, especially 1.25 to 1.75 cm.

Examples of surface care compositions are those used in the field of surface care, for example to clean, treat or polish a surface. Suitable surfaces are, for example, household surfaces such as worktops, as well as surfaces of sanitary ware, such as sinks, basins and lavatories. The ingredients of each composition depend on the use of the composition. Thus, for example, the composition may contain surface active agents such as an anionic, non-ionic, cationic, amphoteric or zwitterionic surface active agents or mixtures thereof.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:
ROSO₃⁻M⁺
wherein R is a linear C₈-C₂₀ hydrocarbyl group and M is a water-solubilising cation. Preferably R is C₁₀-C₁₆ alkyl, or example C₁₂-C₁₄, and M is alkali metal such as lithium, sodium or potassium.

Examples of secondary alkyl sulfate surfactants are those which have the sulfate moiety on a “backbone” of the molecule, for example those of formula:
CH₂ (CH₂)ₙ(CHOSO₃⁻M⁺)(CH₂)ₘCH₃
wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:
CH₂(CH₂)ₓ(CHOSO₃⁻M⁺)CH₃ and
CH₃(CH₂)ₓ(CHOSO₃⁻M⁺)CH₂CH₃
for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:
RO(C₂H₄O)ₙSO₃⁻M⁺
wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium or potassium salts, and alkyl, for example C₈-C₁₈, benzene sulfonates.

Examples of non-ionic surfactants are fatty acid alkoxylates, such as fatty acid ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol non-ionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₁ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further non-ionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type.

The total content of surfactants in the composition is desirably 60 to 95 wt %, especially 75 to 90 wt %. Desirably an anionic surfactant is present in an amount of 50 to 75 wt %, the non-ionic surfactant is present in an amount of 5 to 20 wt %, and/or the cationic surfactant is present in an amount of from 0 to 20 wt %. The amounts are based on the total solids content of the composition, i.e. excluding any solvent which may be present.

The composition, particularly when used as laundry washing or dishwashing composition, may also comprise enzymes, such as protease, lipase, amylase, cellulase and peroxidase enzymes. Such enzymes are commercially available and sold, for example, under the registered trade marks Esperesc, Alcalasc and Savinasc by Nova Industries A/S and Maxatasc by International Biosynthetics, Inc. Desirably the enzymes are present in the composition in an amount of from 0.5 to 3 wt %, especially 1 to 2 wt %.

The composition may, if desired, comprise a thickening agent or gelling agent. Suitable thickeners are polyacrylate polymers such as those sold under the trade mark CARBOPOL, or the trade mark ACUSOL by Rohm and Hass Company. Other suitable thickeners are xanthan gums. The thickener, if present, is generally present in an amount of from 0.2 to 4 wt %, especially 0.5 to 2 wt %.

Dishwasher compositions usually comprise a detergency builder. Suitable builders are alkali metal or ammonium phosphates, polyphosphates, phosphonates, polyphosphonates, carbonates, bicarbonates, borates, polyhydroxysulfonates, polyacetates, carboxylates such as citrates, and polycarboxylates. The builder is desirably present in an amount of up to 90 wt %, preferably 15 to 90 wt %, more preferable 15 to 75 wt %, relative to the total weight of the composition. Further details of suitable components are given in, for example, EP-A-694,059, EP-A-518,720 and WO 99/06522.

The compositions can also optionally comprise one or more additional ingredients. These include conventional detergent composition components such as further surfactants, bleaches, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners, and perfumes. If used, such optional ingredients will generally constitute no more than 10 wt %, for example from 1 to 6 wt %, the total weight of the compositions.

The builders counteract the effects of calcium, or other ion, water hardness encountered during laundering or bleaching use of the compositions herein. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan.

The builders generally constitute from 0 to 3 wt %, more preferably from 0.1 to 1 wt %, by weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt % of the compositions.

The compositions may optionally comprise materials which serve as phase stabilizers and/or co-solvents. Example are C₁-C₃ alcohols such as methanol, ethanol and propanol. C₁-C₃ alkanolamines such as mono-, di- and triethanolamines can also be used, by themselves or in combination with the alcohols. The phase stabilizers and/or co-solvents can, for example, constitute 0 to 1 wt %, preferably 0.1 to 0.5 wt %, of the composition.

The compositions may optionally comprise components which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are NaOH and citric acid.

The containers may themselves be packaged in outer containers if desired, for example non-water soluble containers from which the water-soluble containers are removed before use.

1. A process for cutting or perforating a water-soluble or water-dispersible film or stack of films in the form of a web comprising a plurality of filled and sealed compartments by which a periphery of each compartment is cut or perforated by applying a laser beam to the film or stack of films.

2. A process according to claim 1 wherein the water-soluble film is based upon PVOH.

3. A process according to claim 1 wherein the film is in the form of a laminate.

4. A process according to claims 1 wherein the film is perforated by the laser beam.

5. A process according to claim 1 wherein the film has a thickness of from 20 to 150 μm and the stack of films has a thickness of from 40 to 500 μm.

6. A process for producing a water-soluble or water-dispersible container containing a composition which comprises:
a. producing a base web water-soluble or water-dispersible film containing a plurality of pockets;
b. filling each pocket with a composition;
c. sealing the pockets with a top web water-soluble or water-dispersible film to produce closed containers; and
d. separating at least one container from the plurality of containers by cutting or perforating the combined web along a periphery of said at least one container with a laser beam.

7. A process according to claim 6 wherein the composition is a liquid composition.

8. A process according to claim 6 wherein the composition is selected from the group comprising a fabric care, surface care and dishwashing composition.

9. A process according to claim 6 wherein the composition is selected from the group comprising a dishwashing, water-softening, laundry or detergent composition and a rinse-aid.

10. A process according to claim 6 wherein the composition is selected from the group comprising a disinfectant, antibacterial or antiseptic composition, and a refill composition for a trigger-type spray.

11. A process according to claim 6 wherein the composition is a hazardous composition which is potentially toxic or damaging or detrimental to health or the environment.

12. A process according to claim 6 wherein the composition is a pesticidal composition.

13. A process according to claim 6 wherein the composition is a pharmaceutical or nutraceutical composition.
